(19) United States
(12) Patent Application Publication
(10) Pub. No.: US 2014/0220289 A1
(43) Pub. Date: Aug. 7, 2014

(54) OPTICAL DISK USED FOR FABRICATING GRAPHENE AND METHOD OF MANUFACTURING THE SAME

(71) Applicants: Seoul National University R&DB Foundation, Seoul (KR); TOSHIBA SAMSUNG STORAGE TECHNOLOGY KOREA CORPORATION, Suwon-si (KR)

(72) Inventors: Kil-Soo Choi, Seoul (KR); Byung-Youn Song, Suwon-si (KR); Nag-Eui Choi, Suwon-si (KR); Hyoung-Sub Shim, Seoul (KR); Han-Yung Jung, Seoul (KR); Jung-Hoon Lee, Seoul (KR)

(73) Assignees: Seoul National University R&DB Foundation, Seoul (KR); TOSHIBA SAMSUNG STORAGE TECHNOLOGY KOREA CORPORATION, Suwon-si (KR)

(21) Appl. No.: 14/053,670

(22) Filed: Oct. 15, 2013

(30) Foreign Application Priority Data
Feb. 5, 2013 (KR) 10-2013-0013044

(51) Int. Cl. C01B 31/04; B32B 27/06

(52) U.S. Cl. CPC C01B 31/0446; B32B 27/06
USPC 428/64.1; 428/688; 428/412; 427/162

(57) ABSTRACT

An optical disk for fabricating graphene, a multilayered plate for fabricating graphene, and a method of manufacturing the optical disk or multilayered plate are provided. The optical disk includes a thermoplastic polymer substrate with a reflection layer for reflecting incident light, and a graphite oxide layer applied on the thermoplastic polymer substrate. The method of manufacturing a disk for fabricating graphene involves: obtaining a thermoplastic polymer substrate with a reflection layer for reflecting incident light; and applying a graphite oxide layer on the thermoplastic polymer substrate.

### CROSS-REFERENCE TO RELATED APPLICATION

This application claims the benefit under 35 U.S.C. §119(a) of Korean Patent Application No. 10-2013-0013044, filed on Feb. 5, 2013, in the Korean Intellectual Property Office, the entire disclosure of which is incorporated herein by reference for all purposes.

### BACKGROUND

1. Field

The following description relates to a disk or a multilayered plate for fabricating graphene and a method of producing the same, such as, for example, an optical disk for fabricating graphene and a method of producing such an optical disk using an optical recording and/or reproducing device.

2. Description of Related Art

Graphene is an allotrope of carbon, consisting of a single two-dimensional planar sheet of carbon atoms with a thickness of about 0.35 nanometers. In a graphene sheet, carbon atoms are packed into a honeycomb lattice, forming free spaces therebetween. The arrangement of carbon atoms and spaces therebetween provides a graphene molecule with flexibility that allows a certain degree of deformation, such as bending and twisting. In addition, a hexagonal arrangement of carbon atoms ensures electrical conductivity and chemical stability.

Graphene can carry two hundred times more current than copper and can carry current two hundred times faster than silicon at a room temperature. In addition, graphene has twice the room-temperature thermal conductivity than diamond, and two hundred times more the mechanical strength than steel. Therefore, reaches for utilization of graphene, as one of the most promising future electronic materials, are increasing. Due to such excellent properties, for example, an electrode made of graphene may have both high energy density of a battery and high power performance of a capacitor.

Graphene is generally obtained by an exfoliation method or a synthesis method. In an exfoliation method, a graphene layer may be exfoliated from graphite. Graphite is abundantly present in nature and can be easily obtained. In comparison to a synthesis method, the exfoliation method is characterized with relatively low energy consumption and enables mass production of graphene. However, with the exfoliation method, it is difficult to achieve a graphene sheet having a large surface area, and the method is characterized by a low yield in comparison to the amount of graphite that is processed. The exfoliation method may be further classified into a physical exfoliation method and a chemical exfoliation method, depending on the treatment method used for exfoliating the graphene molecules.

A synthesis method involves synthesizing a layer of graphene directly from a carbon source. In comparison to the exfoliation method, the synthesis method generally requires more energy. However, a graphene sheet having a large area with few defects can be produced with the synthesis method.

However, with the above described methods, limitations exist in effectively forming graphene molecules having a large area surface area and excellent uniformity in the molecular arrangement of carbon atoms. For instance, the actual capacitance per unit weight exhibited by the graphene sheets formed by a general method is 99 to 130 F/g, which is much lower than the highest theoretical capacitance value, 550 F/g.

### SUMMARY

In one general aspect, there is provided an optical disk for fabricating graphene, including: a thermoplastic polymer substrate with a reflection layer for reflecting incident light; and a graphite oxide layer applied on the thermoplastic polymer substrate.

The reflection layer is embedded in the thermoplastic polymer substrate.

The general aspect of optical disk may further include: a separation layer disposed between the thermoplastic polymer substrate and the graphite oxide layer.

The thermoplastic polymer substrate may include: a lower substrate; and an upper substrate disposed above the reflection layer, and the reflection layer may be disposed between the lower substrate and the upper substrate.

The general aspect of optical disk may further include an adhesive layer disposed between the lower substrate and the reflection layer.

The general aspect of optical disk may further include an adhesive layer disposed between the reflection layer and the upper substrate.

The thermoplastic polymer substrate comprises a polycarbonate substrate.

In another general aspect, there is provided a multilayered plate for fabricating graphene, the multilayered plate including: a substrate; a reflection layer formed on a first side of the substrate; and a graphite oxide layer applied on a second side of the substrate.

The multilayered plate may have a shape of a circular optical disk with a central hole.

The multilayered plate may have a rectangular shape or a polygonal shape.

The substrate may include polycarbonate, and the substrate may have a diameter of 11 cm to 13 cm with a planar upper surface.

The general aspect of the multilayered plate may further include: a separation layer disposed between the polymer substrate and the graphite oxide layer; and a lower substrate formed on a bottom surface of the reflection layer.

In another general aspect, there is provided a method of manufacturing a disk for fabricating graphene, the method involving: obtaining a thermoplastic polymer substrate with a reflection layer for reflecting incident light; and applying a graphite oxide layer on the thermoplastic polymer substrate.

The reflection layer may be embedded in the thermoplastic polymer substrate between a lower substrate and an upper substrate.

The general aspect of the method may further involve: prior to the applying of the graphite oxide layer, applying a separation layer between the thermoplastic polymer substrate and the graphite oxide layer so as to separate the thermoplastic polymer substrate from the graphite oxide layer.

The thermoplastic polymer substrate may include a lower substrate; and an upper substrate, the reflection layer being disposed between the lower substrate and the upper substrate.

The thermoplastic polymer substrate may further include an adhesive layer disposed between the lower substrate and the reflection layer.

The thermoplastic polymer substrate may further include an adhesive layer disposed between the reflection layer and the upper substrate.

The thermoplastic polymer substrate may be a polycarbonate substrate.

Other features and aspects will be apparent from the following detailed description, the drawings, and the claims.

### BRIEF DESCRIPTION OF THE DRAWINGS

FIG. 1 is a diagram illustrating an example of a disk with a separation coating layer for fabricating graphene.

FIG. 2 is a diagram illustrating another example of a disk with a separation coating layer for fabricating graphene.

FIG. 3 is a diagram illustrating an example of a disk without a separation layer for fabricating graphene.

FIG. 4 is a diagram illustrating another example of a disk without a separation layer for fabricating graphene.

FIG. 5(a)-(d) is a perspective view of additional examples of a disk or a multilayered plate for fabricating graphene.

FIG. 6 is a plan view of another example of a disk for fabricating graphene.

FIG. 7 is a flowchart illustrating an example of a method of manufacturing a disk used for fabricating graphene.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

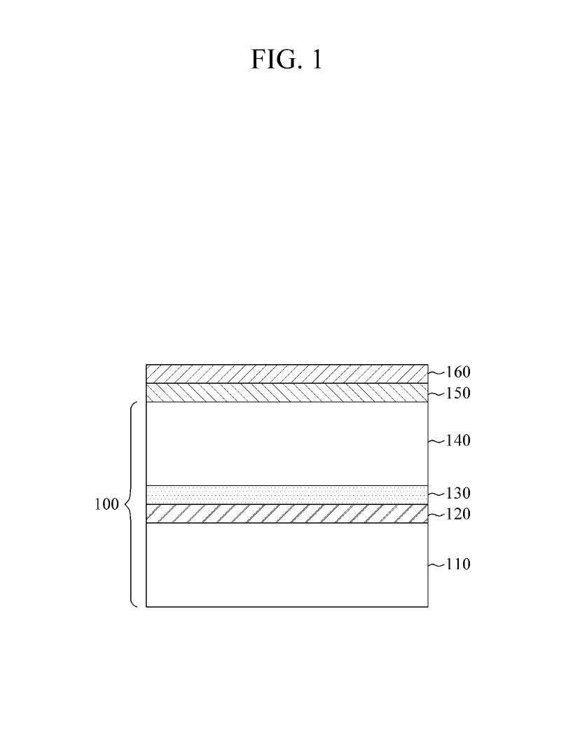

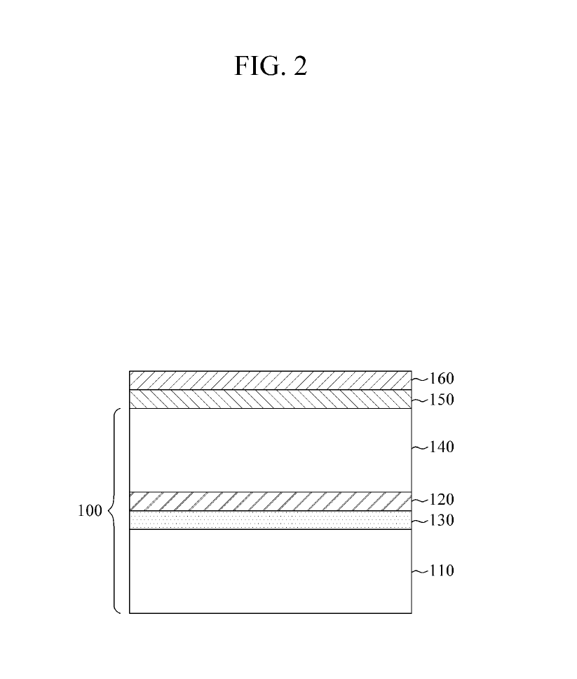

FIGS. 1 and 2 are diagrams illustrating examples of a disk with a separation coating layer for fabricating graphene. The disk may be an optical disk.

Referring to FIGS. 1 and 2, a disk used for fabricating graphene may include a thermoplastic polymer substrate 100 and a graphite oxide layer 160 applied to the thermoplastic polymer substrate 100. Here, the disk may further include a separation coating layer 150 interposed to separate the graphite oxide layer 160 and the thermoplastic polymer substrate 100. The separation coating layer 150 may be made of a high molecular resin composition, such as PET (Polyethylene Terephthalate), while its material is not limited thereto.

Meanwhile, the thermoplastic polymer substrate 100 may have a reflection layer 120 embedded therein so as to reflect incident light. For example, the thermoplastic polymer substrate 100 may include a lower substrate 110, a reflection layer 120 above the lower substrate 110, an adhesive layer 130 above the reflection layer 120, and an upper substrate 140 above the adhesive layer 130. In addition, as shown in FIG. 2, the positions of the reflection layer 120 and the adhesive layer 130 may be switched, and in this case, the thermoplastic polymer substrate 100 may include the lower substrate 110, the adhesive layer 130 above the lower substrate 110, the reflection layer 120 above the adhesive layer 130, and the upper substrate 140 above the reflection layer 120.

The thermoplastic polymer substrates 100, 110, and 140 may be polycarbonate substrates. Polycarbonate, as a member of a particular thermoplastic polymer group, is capable of being easily manipulated, injection-molded and thermoformed. Polycarbonate is multifunctional engineering plastic with excellent heat-resistance, impact resistance, and optical properties, thereby being widely used for product plastic and engineering plastic and also as a material for exteriors of information electronics, such as, mobile phones, notebook computers and monitors, and optical storage media, such as CDs and DVDs.

Although polycarbonate is used in this example as the polymer material for forming the thermal polymer substrates 110 and 140, the substrates may be made of different types of materials, including other polymers or composite materials. Also, the lower substrate 110 and the upper substrate 140 may be made from the same material or a different material.

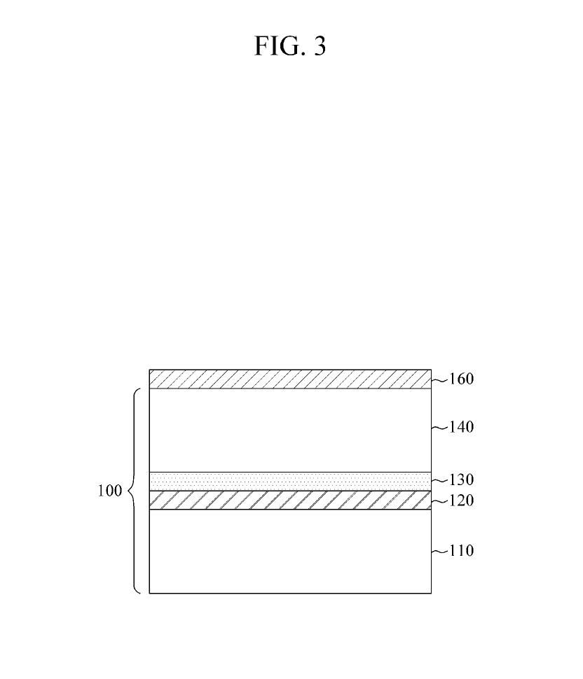

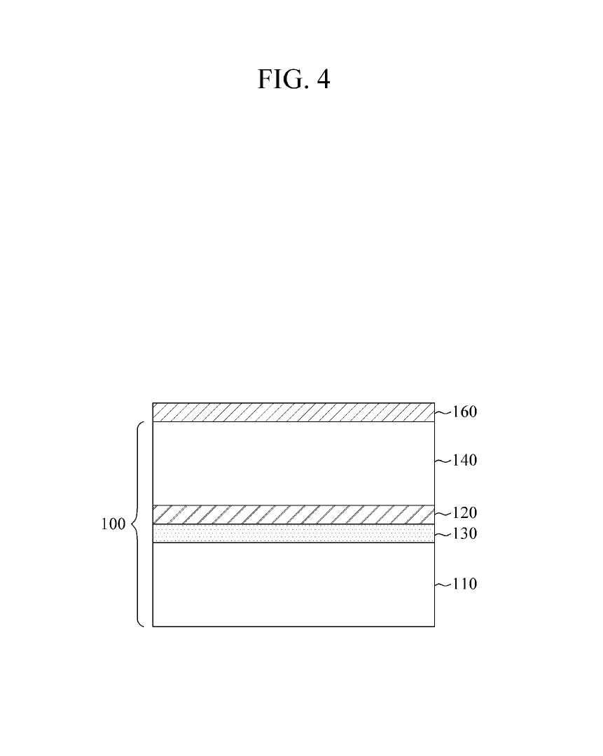

FIGS. 3 and 4 are examples of diagrams illustrating a disk without a separation coating layer for fabricating graphene. The disk may be an optical disk.

As shown in FIGS. 3 and 4, unlike the disk illustrated in FIGS. 1 and 2, the disk used for fabricating graphene does not include a separation coating layer 150. The disk shown in FIGS. 3 and 4 only includes a thermoplastic polymer substrate 100 and a graphite oxide layer 160 because a layer of reduced graphite oxide can be used without being separated from the thermoplastic polymer substrate 100.

For example, as shown in FIG. 3, the thermoplastic polymer substrate 100 may include a lower substrate 110, a reflection layer 120 above the lower substrate 110, an adhesive layer 130 above the reflection layer 120, and an upper substrate 140 above the adhesive layer 130. Also, the positions of the reflection layer 120 and the adhesive layer 130 may be switched. In such a case, as shown in FIG. 4, the thermoplastic polymer substrate 100 may include the lower substrate 110, the adhesive layer 130 above the lower substrate 110, the reflection layer 120 above the adhesive layer 130, and the upper substrate 140 above the reflection layer 120.

The overall structure of examples of disks illustrated in FIGS. 1 to 4 may be similar to that of a general DVD or CD, excluding the separation coating layer 150 and the graphite oxide layer 160.

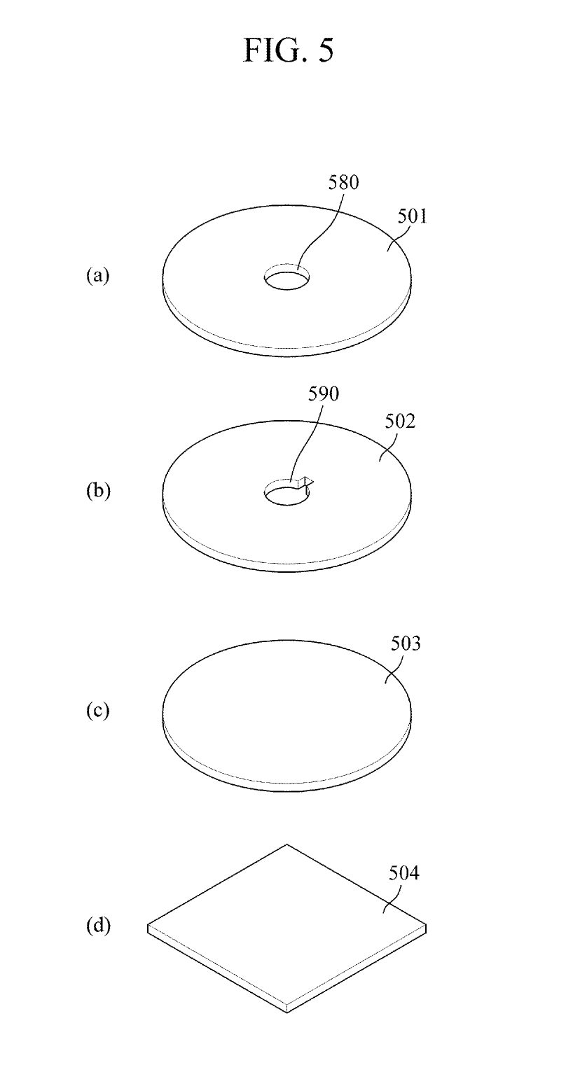

FIG. 5(a)-(d) illustrate additional examples of disks and multilayered plates that may be used to fabricate graphene. FIG. 5(a) illustrates an example of a disk 501 having a central hole, like that of an optical disk such as CDs and DVDs. The shape and dimension of the disk 501 may be similar to that of a standard CDs and DVDs, for example. The disk 501 may be a multilayered plate having a layer arrangement shown in FIGS. 1-4. For example, the thermoplastic polymer substrate 100 of the disk 501 may have a diameter in a range of 7 cm to 30 cm, or 11 cm to 13 cm. However, these dimensions of the thermoplastic polymer substrate 100 are provided as an example, and the dimension may widely vary.

FIGS. 5(b) and 5(c) illustrate additional examples of disks 502, 503 that may be used to fabricate graphene. The arrangement of layers within the disks 502, 503 may be the same as the examples of optical disks illustrated in FIGS. 1-4. The disks 502, 503 may be an optical disk. The disk 502 illustrated in FIG. 5(b) include a notch along a central hole to facilitate the rotation of the disk. However, the optical disk according to the present disclosure is not limited to the exact shape of the central hole or notch shown in FIG. 5(b). Other shapes of optical disks having a different external shape that allows rotation in a standard optical recording or reproducing device are within the scope of the present disclosure. In addition, as illustrated in FIG. 5(c), the disk 503 may have a planar upper surface without a central hole. Nevertheless, the disk 503 may be configured to be rotated by a rotating device through a latch on the bottom surface of the disk 503. Further, as illustrated in FIG. 5(d), the disk 504 may be a multilayered plate that is not circular in shape. For example, the disk 504 may have an oval shape, an elliptical shape, a rectangular shape, or a polygonal shape.

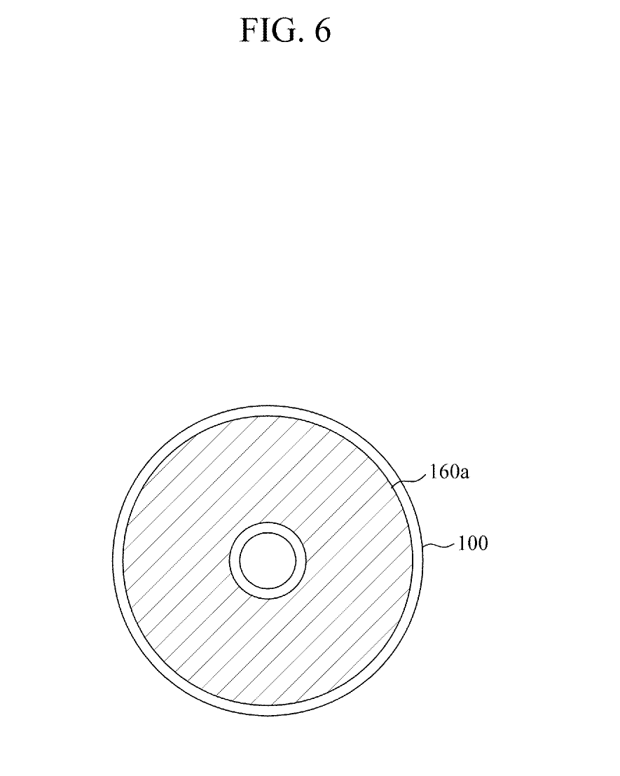

FIG. 6 illustrates a plan view of another example of a disk for fabricating graphene. The illustrated disk may be an optical disk. The optical disk illustrated in FIG. 6 may have an internal arrangement of a lower substrate 110, a reflection layer 120, an adhesive layer 130, and an upper substrate 140 as shown in FIGS. 1-4, and the graphite oxide layer 160 and the separation coating layer 150 may be applied over either an entire surface of the optical disk or over a portion of the optical disk. In the example illustrated in FIG. 6, the graphite oxide layer 160a is formed only in an inner portion of the optical disk. The separation coating layer 150 likewise may be formed over an entire surface of the thermoplastic polymer substrate 100 or only under a portion where the graphite oxide layer 160a is applied.

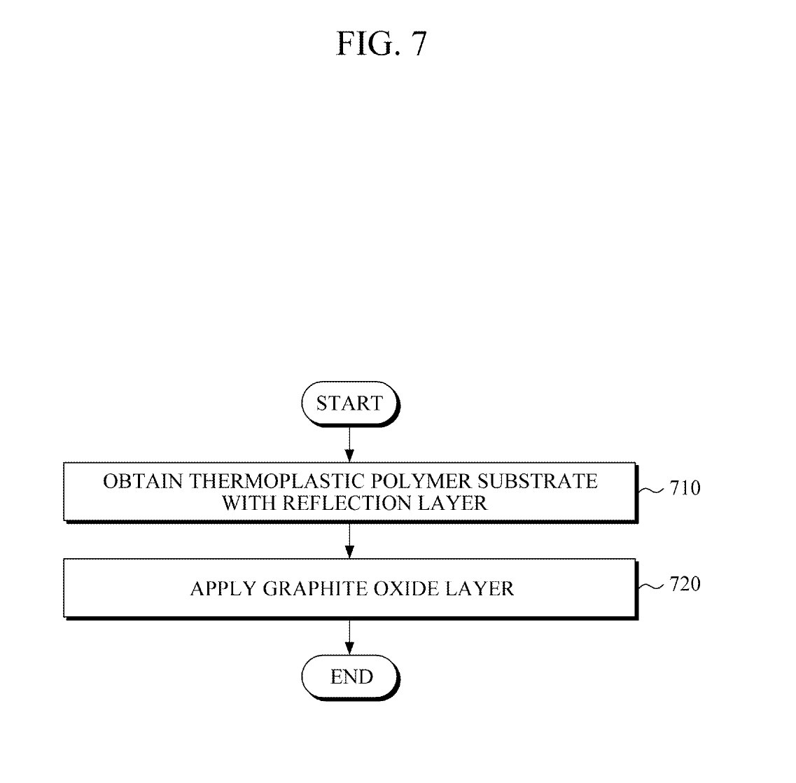

FIG. 7 is a flowchart illustrating an example of a method of fabricating a disk that may be used for fabricating graphene.

First, a thermoplastic polymer substrate with a reflection layer embedded therein for reflecting incident light is prepared in 710. A thin film layer of graphite oxide (GO) is applied onto the thermoplastic polymer substrate in 720. The thermoplastic polymer substrate may be an optical disk.

The thin film layer of graphite oxide may be formed on the thermoplastic polymer substrate by dropping droplets of a GO solution onto the thermoplastic polymer substrate. This method is known as a drop-casting method. The thermoplastic polymer substrate may be rotated with an optical disk recording and/or reproducing device during the dropping of the GO solution to ensure a uniform application of the thin film layer.

In the alternative, the thin film layer of graphite oxide may be formed on the thermoplastic polymer using a vacuum filtering GO dispersion method, while a rotating device such as an optical disk recording and/or reproducing device is turning the thermoplastic polymer substrate.

To make a GO solution, graphite powder with high purity is first fabricated using modified Hummers method or the like. The resulting powder is dispersed into water by applying an ultrasonic treatment, uniformly distributing the graphite oxide in the water to obtain a homogenous mixture. The uniform mixture may be used as the GO solution. For example, the graphite powder may be dispersed at a density of 3.7 mg/ml with an ultrasonic treatment or other dispersion method. Then, the resulting GO solution is dropped or applied to the substrate. Examples of methods of applying the GO solution onto the thermoplastic polymer substrate may include the drop-casting method or the vacuum filtering GO dispersion method, as described above. In one example, the substrate with the GO solution applied thereon is air dried for 24 hours.

Prior to the application of the GO layer in operation 720, a separation coating layer may be further applied between the thermoplastic polymer substrate and the GO layer to separate the two layers. Various materials can be used to form the separation coating layer. For example, the separation coating layer may include a thin plastic film, such as a PET film laminated or coated on the thermoplastic polymer substrate, or a layer of surfactant applied to a surface of the thermoplastic polymer substrate.

In addition, the thermoplastic polymer substrate may include a reflection layer embedded therein. The reflection layer may be made with substance similar to that found in a standard DVD or CD, and may reflect light reflected on the surface of the polycarbonate substrate.

Described above are examples of disks and multilayered plates used for fabricating graphene, and examples of methods of producing such a disk using an optical recording and/or reproducing device. The optical disk may include a thermoplastic polymer substrate with a reflection layer embedded therein for reflecting incident light; and a thin-film of graphite oxide layer applied onto the thermoplastic polymer substrate. As a result, mass-production of high-quality graphene is made possible at a low cost.

As described above, the thermoplastic polymer substrate may be a polycarbonate substrate, and may have a similar structure as that of a general DVD or CD. In particular, the polycarbonate substrate may be a transparent substrate.

According to the above-described methods, mass production of high-quality graphene is possible at a low cost by using a structure of a general optical disk. In addition, graphene made according to the methods described above may have superior properties in comparison to graphene made by different methods.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical disk for fabricating graphene, the optical disk comprising:
a thermoplastic polymer substrate with a reflection layer for reflecting incident light; and
a graphite oxide layer applied on the thermoplastic polymer substrate.

2. The optical disk of claim 1, wherein the reflection layer is embedded in the thermoplastic polymer substrate.

3. The optical disk of claim 1, further comprising:
a separation layer disposed between the thermoplastic polymer substrate and the graphite oxide layer.

4. The optical disk of claim 1, wherein the thermoplastic polymer substrate comprises:
a lower substrate; and
an upper substrate disposed above the reflection layer,
wherein the reflection layer is disposed between the lower substrate and the upper substrate.

5. The optical disk of claim 4, further comprising:
an adhesive layer disposed between the lower substrate and the reflection layer.

6. The optical disk of claim 4, further comprising:
an adhesive layer disposed between the reflection layer and the upper substrate.

7. The optical disk of claim 1, wherein the thermoplastic polymer substrate comprises a polycarbonate substrate.

8. A multilayered plate for fabricating graphene, the multilayered plate comprising:
a substrate;
a reflection layer formed on a first side of the substrate; and
a graphite oxide layer applied on a second side of the substrate.

9. The multilayered plate of claim 8, wherein the multilayered plate has a shape of a circular optical disk with a central hole.

10. The multilayered plate of claim 9, wherein the multilayered plate is formed in a rectangular shape or a polygonal shape.

11. The multilayered plate of claim 9, wherein the substrate comprises polycarbonate, and the substrate has a diameter of 11 cm to 13 cm with a planar upper surface.

12. The multilayered plate of claim 11, further comprising:
a separation layer disposed between the polymer substrate and the graphite oxide layer; and
a lower substrate formed on a bottom surface of the reflection layer.

13. A method of manufacturing a disk for fabricating graphene, the method comprising:
obtaining a thermoplastic polymer substrate with a reflection layer for reflecting incident light; and
applying a graphite oxide layer on the thermoplastic polymer substrate.

14. The method of claim 13, wherein the reflection layer is embedded in the thermoplastic polymer substrate between a lower substrate and an upper substrate.

15. The method of claim 13, further comprising:
prior to the applying of the graphite oxide layer, applying a separation layer between the thermoplastic polymer substrate and the graphite oxide layer so as to separate the thermoplastic polymer substrate from the graphite oxide layer.

16. The method of claim 13, wherein the thermoplastic polymer substrate comprises:
a lower substrate; and
an upper substrate, the reflection layer being disposed between the lower substrate and the upper substrate.

17. The method of claim 16, wherein the thermoplastic polymer substrate further comprises an adhesive layer disposed between the lower substrate and the reflection layer.

18. The method of claim 16, wherein the thermoplastic polymer substrate further comprises an adhesive layer disposed between the reflection layer and the upper substrate.

19. The method of claim 13, wherein the thermoplastic polymer substrate is a polycarbonate substrate.
